(19) United States
(12) Patent Application Publication
(10) Pub. No.: US 2024/0306541 A1
(43) Pub. Date: Sep. 19, 2024

(54) LAWN MAINTENANCE MACHINE

(71) Applicant: MAKITA CORPORATION, Anjo-shi (JP)

(72) Inventor: Hiroki SUGIYAMA, Anjo-shi (JP)

(73) Assignee: MAKITA CORPORATION, Anjo-shi (JP)

(21) Appl. No.: 18/601,208

(22) Filed: Mar. 11, 2024

(30) Foreign Application Priority Data
Mar. 15, 2023 (JP) 2023-040570

(51) Int. Cl. A01D 34/78; A01D 34/00; A01D 101/00

(52) U.S. Cl. CPC A01D 34/78; A01D 34/006; A01D 2101/00

(57) ABSTRACT

A lawn maintenance machine may include: a pair of wheels configured to rotate on a ground; a handle unit configured to be gripped by a user while the lawn maintenance machine is moving; a working unit configured to work on the ground; an electric motor configured to drive the working unit; a fan configured to rotate by operation of the electric motor; a housing configured to support the working unit and housing the electric motor and the fan; and a wall disposed outside the housing and attached to the housing. The housing may have a connection opening which connects an inside and an outside of the housing and through which air flows by a rotation of the fan. The wall may be disposed to face the connection opening.

### REFERENCE TO RELATED APPLICATIONS

This application claims priority to Japanese Patent Application No. 2023-40570, filed on Mar. 15, 2023, the entire contents of which are hereby incorporated by reference into the present application.

### TECHNICAL FIELD

This disclosure herewith relates to a lawn maintenance machine.

### BACKGROUND ART

Japanese Patent Application Publication No. H8-256554 describes a lawnmower. The lawnmower includes a pair of wheels that rotates on the ground, a handle unit to be gripped by a user while the lawnmower is moving, a working unit that works on the ground, an electric motor that drives the working unit, and a housing that supports the working unit and houses the electric motor.

### SUMMARY

In the working machine as described in Japanese Patent Application Publication H8-256554, the housing may have a connection opening that connects the inside of the housing to the outside and through which air can flow in order to cool the motor. In such a working machine, for example, when the working machine is being washed with liquid, the liquid may flow through the connection opening and into the housing. The present disclosure provides a technique that can suppress liquid from flowing into a housing.

A lawn maintenance machine disclosed herein may be configured to maintain a lawn on a ground as the lawn maintenance machine moves on the ground forward. The lawn maintenance machine may comprise: a pair of wheels configured to rotate on the ground; a handle unit configured to be gripped by a user while the lawn maintenance machine is moving; a working unit configured to work on the ground; an electric motor configured to drive the working unit; a fan configured to rotate by operation of the electric motor; a housing configured to support the working unit and housing the electric motor and the fan; and a wall disposed outside the housing and attached to the housing. The housing may have a connection opening which connects an inside and an outside of the housing and through which air flows by a rotation of the fan. The wall may be disposed to face the connection opening.

According to the above configuration, when the lawn maintenance machine is being washed with liquid, the liquid hits the wall, by which the liquid can be suppressed from reaching the connection opening. This can suppress the liquid from flowing into the housing through the connection opening.

### BRIEF DESCRIPTION OF DRAWINGS

FIG. 1 illustrates a perspective view of a lawn maintenance machine 2 of an embodiment.

FIG. 2 illustrates a cross-sectional view of a connection point between an upper housing 26 and a lower housing 28 of the embodiment.

FIG. 3 illustrates an exploded view of a right handle bracket 110 of the lawn maintenance machine 2 of the embodiment and its vicinity with a right front wheel 60 detached.

FIG. 4 illustrates a perspective view of a second connection port 44 of the lawn maintenance machine 2 of the embodiment and its vicinity.

FIG. 5 illustrates a perspective view of the lawn maintenance machine 2 of the embodiment with a battery cover 14 opened.

FIG. 6 illustrates a cross-sectional view of a cutter unit 130 of the lawn maintenance machine 2 of the embodiment and its vicinity.

FIG. 7 illustrates a perspective view of a front wheel unit 22 and a height adjustment unit 24 of the embodiment.

FIG. 8 illustrates a perspective view of the vicinity of the height adjustment unit 24 in the front wheel unit 22 and the height adjustment unit 24 of the embodiment.

FIG. 9 illustrates a cross-sectional view of the height adjustment unit 24 of the embodiment.

FIG. 10 illustrates a cross-sectional view of the right front wheel 60 of the lawn maintenance machine 2 of the embodiment and its vicinity.

FIG. 11 illustrates a cross-sectional view of an electric motor 122 of the lawn maintenance machine 2 of the embodiment and its vicinity.

FIG. 12 illustrates a cross-sectional view of a second connection port 44 of the lawn maintenance machine 2 of the embodiment and its vicinity.

FIG. 13 illustrates a perspective view of the electric motor 122, a fan 126, a transmitting unit 128, and a cutter unit 130 of the embodiment.

FIG. 14 illustrates a cross-sectional view of the cutter unit 130 of the lawn maintenance machine 2 of the embodiment and its vicinity.

FIG. 15 illustrates a perspective view of an attaching unit 178 of the embodiment.

FIG. 16 illustrates a perspective view of the attaching unit 178 of the embodiment.

FIG. 17 illustrates an exploded perspective view of a right shaft insertion opening 198 of the attaching unit 178 of the embodiment and its vicinity.

FIG. 18 illustrates an exploded perspective view of a left shaft insertion opening 216 of the attaching unit 178 of the embodiment and its vicinity.

FIG. 19 illustrates a left side view of a battery attaching unit 16, battery packs BP, the front wheel unit 22, a control unit 120, the electric motor 122, the fan 126, and the cutter unit 130 of the embodiment.

FIG. 20 illustrates a rear view of the battery attaching unit 16, the battery packs BP, the front wheel unit 22, the control unit 120, the electric motor 122, the fan 126, and the cutter unit 130 of the embodiment.

FIG. 21 illustrates a top view of the battery attaching unit 16, the battery packs BP, the front wheel unit 22, the control unit 120, the electric motor 122, the fan 126, and the cutter unit 130 of the embodiment.

FIG. 22 illustrates a perspective view of the cutter unit 130 of the embodiment.

FIG. 23 illustrates a perspective view of a shaft 232 of the embodiment.

FIG. 24 illustrates an exploded perspective view of the cutter unit 130 of the embodiment.

FIG. 25 illustrates a front view of the cutter unit 130 of the embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved lawn maintenance machines, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the wall may be disposed between the connection opening and one of the pair of wheels.

As the lawn maintenance machine moves on the ground, soil and lawn may adhere to the wheel. According to the above configuration, even when the wheel is washed with liquid, the liquid hits the wall, by which the liquid can be suppressed from reaching the connection opening. This can suppress the liquid from flowing into the housing through the connection opening.

In one or more embodiments, the wall may be a handle bracket connecting the handle unit and the housing.

According to the above configuration, the handle unit and the housing can be connected using one component, and liquid can be suppressed from flowing into the housing through the connection opening when the lawn maintenance machine is washed with the liquid.

In one or more embodiments, the electric motor may at least partially overlap at least one of the pair of wheels when the lawn maintenance machine is viewed along a rotation axis of the pair of wheels.

According to the above configuration, the electric motor, which is a heavy object, is arranged in the vicinity of the ground. This can suppress the housing from tilting with respect to the ground when an external force acts on the housing, as compared to a configuration in which the electric motor is not arranged in the vicinity of the ground.

In one or more embodiments, the lawn maintenance machine may further comprise a control unit housed in the housing and configured to control the electric motor. The control unit may at least partially overlap the electric motor when the lawn maintenance machine is viewed from a rear side.

When the fan rotates, air flows through the electric motor. According to the above configuration, the distance between the electric motor and the control unit can be shortened. This allows the control unit to be cooled more efficiently by the air flowing through the electric motor.

In one or more embodiments, the control unit may be disposed forward of the electric motor.

According to the above configuration, the space rearward of the electric motor can be made more compact than a configuration in which the control unit is arranged rearward of the electric motor. Thus, for example, when the working unit is arranged rearward of the electric motor, the distance between the electric motor and the working unit can be shortened.

In one or more embodiments, the lawn maintenance machine may further comprise a battery configured to supply electric power to the electric motor. The battery may at least partially overlap the electric motor when the lawn maintenance machine is viewed along the rotation axis of the pair of wheels.

According to the above configuration, the battery, which is a heavy object, is arranged in the vicinity of the ground. This can suppress the housing from tilting with respect to the ground when an external force acts on the housing, as compared to a configuration in which the battery is not arranged in the vicinity of the ground.

In one or more embodiments, the housing may have a drain opening disposed closer to the ground than the connection opening and connecting the inside and the outside of the housing. The drain opening may be disposed at a position facing one of the pair of wheels.

According to the above configuration, even when liquid flows into the housing through the connection opening, the liquid can be drained out of the housing through the drain opening. In addition, when the lawn maintenance machine is being washed with liquid, the liquid hits the wheel, by which the liquid can be suppressed from reaching the drain opening. This can suppress the liquid from flowing into the housing through the drain opening.

### Embodiments

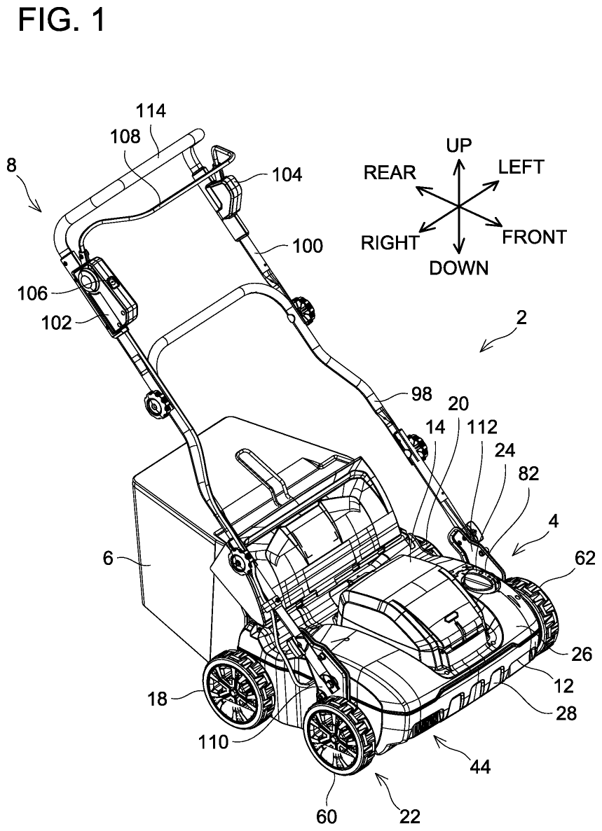

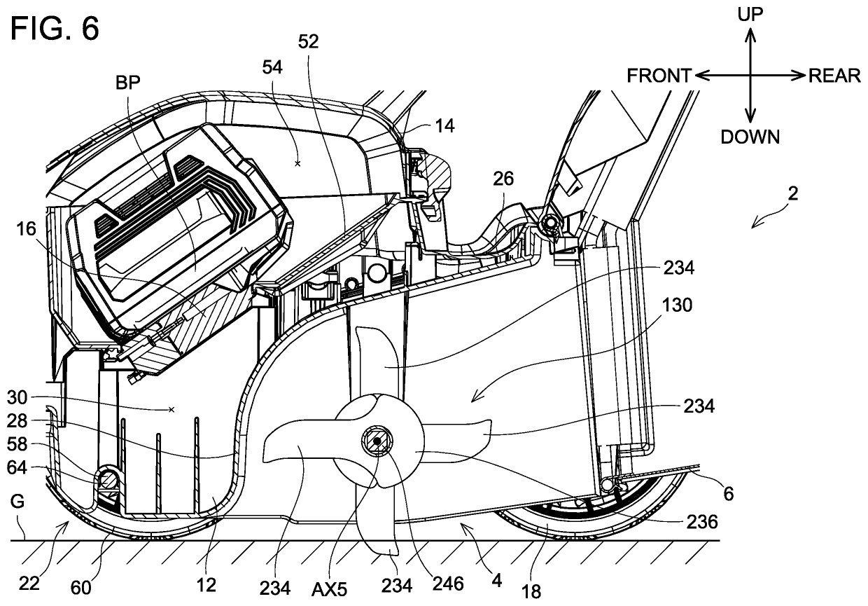

As illustrated in FIG. 1, a lawn maintenance machine 2 is configured to maintain a lawn on the ground G as it moves on the ground G (see FIG. 6). Specifically, the lawn maintenance machine 2 performs dethatching to remove dead grass and leaves, grass debris generated by mowing, and the like (thatches) on the ground G. The lawn maintenance machine 2 also performs aeration to supply oxygen to the roots of the lawn and soil on the ground G by tilling the ground G. Furthermore, the lawn maintenance machine 2 performs cutting to cut the lawn on the ground G.

The lawn maintenance machine 2 comprises a body unit 4, a grass collection box 6, and a handle unit 8. The grass collection box 6 is detachably attached to the rear end of the body unit 4. The grass collection box 6 collects grass cut by the lawn maintenance machine 2 and grass, leaves, and the like that have fallen on the ground G. The handle unit 8 is attached to the body unit 4. The user moves the lawn maintenance machine 2 by standing behind the lawn maintenance machine 2, grasping an upper portion of the handle unit 8 with both hands, and pushing it forward or pulling it rearward. Hereafter, a direction in which the lawn maintenance machine 2 moves and which is along the ground G is referred to as a front-rear direction, a direction orthogonal to the ground G is referred to as an up-down direction, and a direction orthogonal to the front-rear direction and the up-down directions is referred to as a left-right direction.

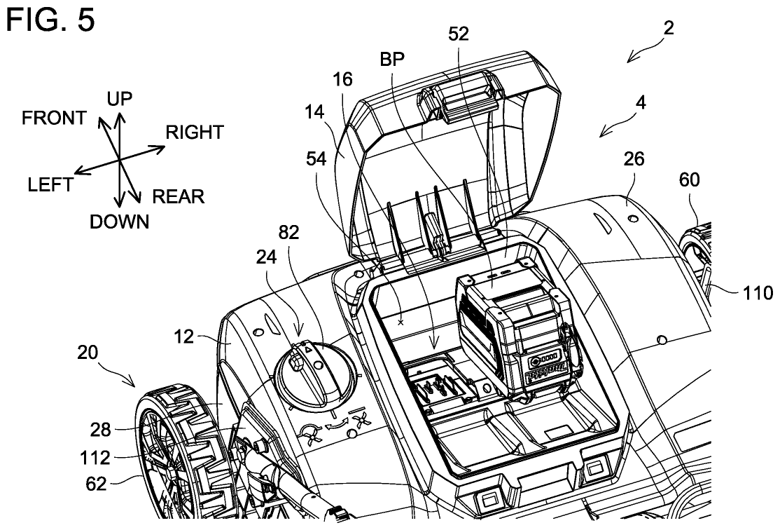

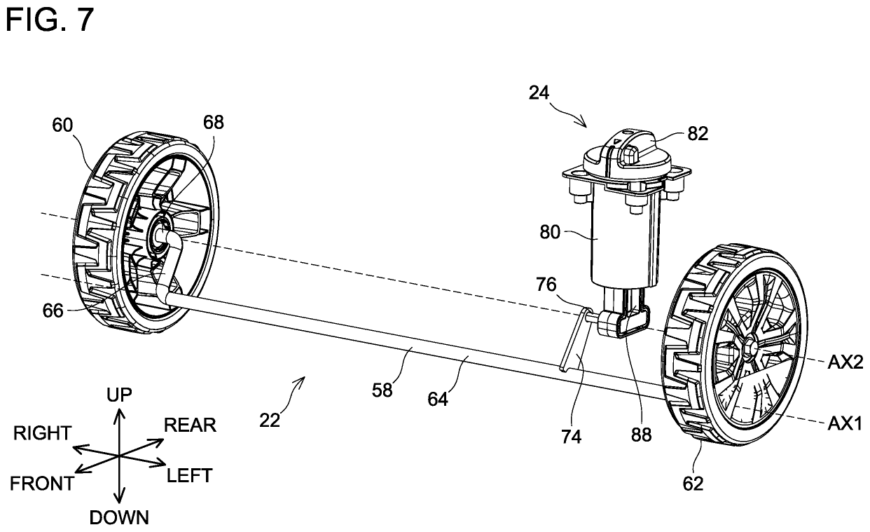

The body unit 4 comprises a housing 12, a battery cover 14, a battery attaching unit 16 (see FIG. 5), battery packs BP (see FIG. 5), a right rear wheel 18, a left rear wheel 20, a front wheel unit 22, and a height adjustment unit 24 (see FIG. 7). The housing 12 comprises an upper housing 26 that defines the external shape of the upper portion of the housing 12 and a lower housing 28 that defines the external shape of the lower portion of the housing 12. The housing 12 includes an interior space 30 (see FIG. 6) defined by the upper housing 26 and the lower housing 28.

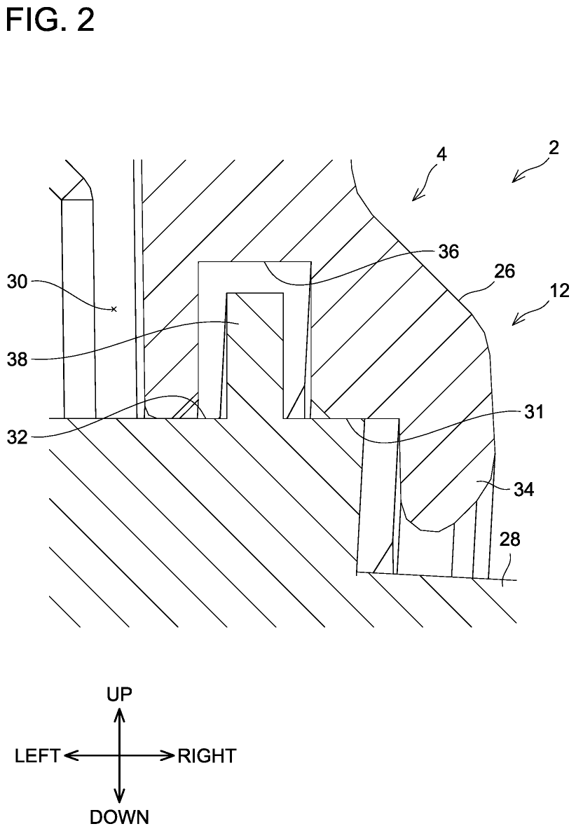

As illustrated in FIG. 2, at a point where the upper housing 26 connects with the lower housing 28, an upper contact surface 31 of the upper housing 26 is in contact with a lower contact surface 32 of the lower housing 28. The upper housing 26 comprises an upper protruding wall 34 and a receiving groove 36. The upper protruding wall 34 protrudes downward from the upper contact surface 31. The upper protruding wall 34 is exposed to the outside of the lawn maintenance machine 2. The lower end of the upper protruding wall 34 is positioned downward of the lower contact surface 32. The receiving groove 36 is recessed upward from the upper contact surface 31. The receiving groove 36 is closer to the interior space 30 than the upper protruding wall 34 is. The lower housing 28 comprises a lower protruding wall 38. The lower protruding wall 38 protrudes upward from the lower contact surface 32. The lower protruding wall 38 is received in the receiving groove 36. The upper protruding wall 34, the receiving groove 36, and the lower protruding wall 38 form a labyrinth structure. This can suppress liquid from flowing through between the upper housing 26 and the lower housing 28 and entering the interior space 30.

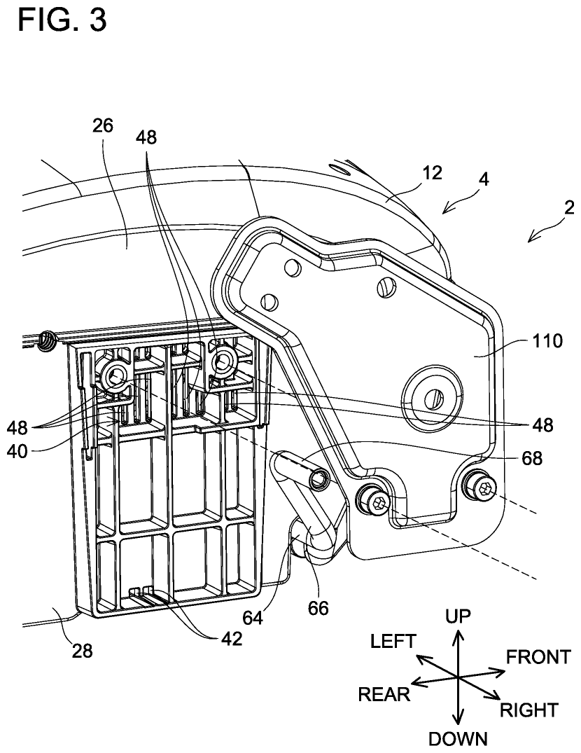

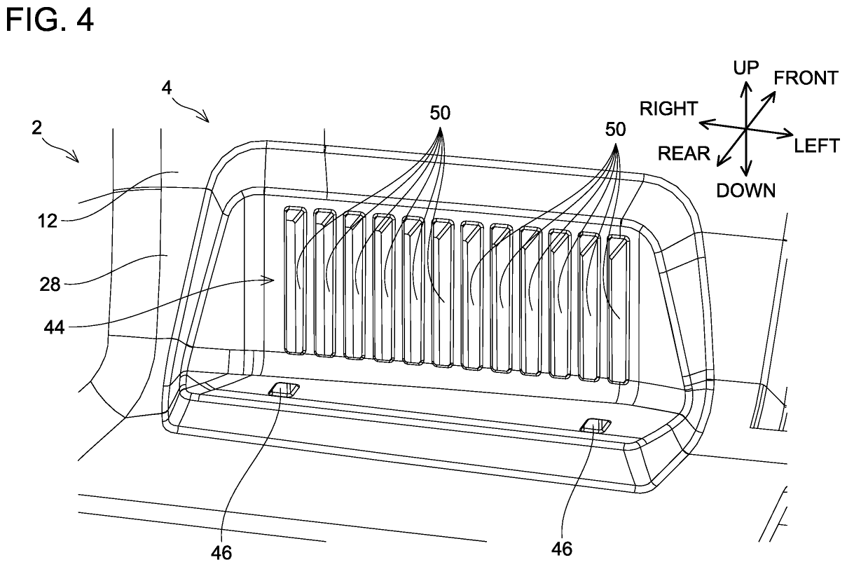

As illustrated in FIGS. 3 and 4, the housing 12 comprises a first connection port 40, first drain openings 42, a second connection port 44, and second drain openings 46. As illustrated in FIG. 3, the first connection port 40 and the first drain openings 42 are arranged at a front right portion of the lower housing 28. The first connection port 40 and the first drain openings 42 are positioned downward of (i.e., on the ground G side of) the connection point between the upper housing 26 and the lower housing 28. The first connection port 40 and the first drain openings 42 penetrate the lower housing 28 in the left-right direction. The first connection port 40 and the first drain openings 42 connect the interior space 30 (see FIG. 6) of the housing 12 to the outside. The first connection port 40 comprises a plurality of first connection openings 48 aligned in the front-rear direction. The first connection openings 48 are openings elongated in the up-down direction. The first drain openings 42 are positioned downward of (i.e., on the ground G side of) the first connection port 40.

As illustrated in FIGS. 1 and 4, the second connection port 44 and the second drain openings 46 are arranged at a front right portion of the lower housing 28. The second connection port 44 and the second drain openings 46 are positioned downward of (i.e., on the ground G side of) the connection point between the upper housing 26 and the lower housing 28. As illustrated in FIG. 4, the second connection port 44 penetrates the lower housing 28 in the front-rear direction. The second drain openings 46 also penetrate the lower housing 28 in the up-down direction. The second connection port 44 and the second drain openings 46 connect the interior space 30 (see FIG. 6) of the housing 12 to the outside. The second connection port 44 comprises a plurality of second connection openings 50 aligned in the left-right direction. The second connection openings 50 are openings elongate in the up-down direction. The second drain openings 46 are positioned downward of (i.e., on the ground G side of) the second connection port 44. The second drain openings 46 are disposed rearward of the second connection port 44.

As illustrated in FIG. 5, the upper housing 26 includes a recess 52 recessed downward from the upper surface, and the battery cover 14 is attached to the upper housing 26 at a position forward of the recess 52. The battery cover 14 pivots between a closed position (see FIG. 6) and an open position. A pivot axis of the battery cover 14 is positioned forward of the recess 52. As illustrated in FIG. 6, when the battery cover 14 is in the closed position, the battery cover 14 covers the recess 52. This defines a housing space 54 between the upper housing 26 and the battery cover 14. The recess 52 constitutes a part of the housing space 54. As illustrated in FIG. 5, when the battery cover 14 is in the open position, the recess 52 is not covered.

The battery attaching unit 16 is fixed to the upper housing 26 in the recess 52. Two battery packs BP are detachably attached to the battery attaching unit 16. In FIG. 5, illustration of one battery pack BP is omitted for easier view of the battery attaching unit 16. The two battery packs BP are arranged in the left-right direction. Each of the battery packs BP is attached to the battery attaching unit 16 by sliding the battery pack BP forward and downward with respect to the battery attaching unit 16 with the battery cover 14 in the open position, and the battery pack BP is detached from the battery attaching unit 16 by sliding the battery pack BP rearward and upward with respect to the battery attaching unit 16. The battery packs BP comprise rechargeable batteries, such as lithium-ion batteries, for example.

As illustrated in FIG. 1, the right rear wheel 18 is rotatably attached to the vicinity of the rear right end of the lower housing 28. The left rear wheel 20 is rotatably attached to the vicinity of the rear left end of the lower housing 28. The front wheel unit 22 is attached to the vicinity of the front end of the lower housing 28. The height adjustment unit 24 is fixed to an upper left portion of the upper housing 26.

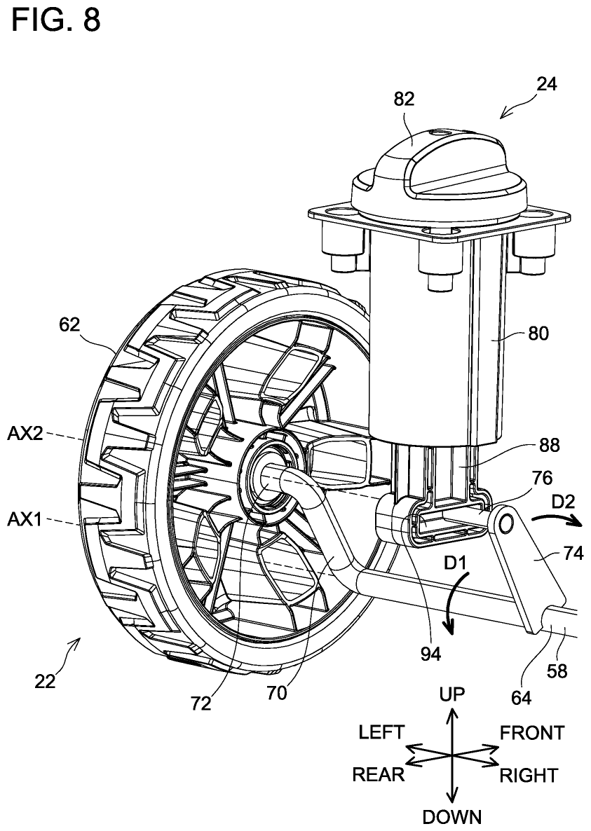

As illustrated in FIG. 7, the front wheel unit 22 comprises a shaft 58, a right front wheel 60, and a left front wheel 62. As illustrated in FIGS. 7 and 8, the shaft 58 comprises a central shaft portion 64, a right connection portion 66, a right shaft portion 68, a left connection portion 70, a left shaft portion 72, a plate portion 74, and a pin portion 76. The central shaft portion 64 extends in the left-right direction. As illustrated in FIG. 6, the central shaft portion 64 is attached to a lower portion of the front end of the lower housing 28 from below. The central shaft portion 64 is rotatable with respect to the lower housing 28 and is supported by the lower housing 28 such that it cannot move in the up-down direction or in the front-rear direction. As illustrated in FIG. 7, the pivot axis AX1 of the central shaft portion 64 extends in the left-right direction. The right connection portion 66 connects the right end of the central shaft portion 64 with the left end of the right shaft portion 68. The right shaft portion 68 extends in the left-right direction. The right shaft portion 68 is offset from the central shaft portion 64. The right shaft portion 68 rotatably supports the right front wheel 60. The right front wheel 60 rotates about a rotation axis AX2 extending in the left-right direction. The rotation axis AX2 is offset from the pivot axis AX1.

As illustrated in FIG. 8, the left connection portion 70 connects the left end of the central shaft portion 64 to the right end of the left shaft portion 72. The left shaft portion 72 is offset from the central shaft portion 64. The central axis of the left shaft portion 72 and the central axis of the right shaft portion 68 are substantially identical. The left shaft portion 72 rotatably supports the left front wheel 62. The left front wheel 62 rotates about the rotation axis AX2. That is, the left front wheel 62 and the right front wheel 60 rotate on the same axis. The plate portion 74 extends from the central shaft portion 64 in a direction orthogonal to the central shaft portion 64. The pin portion 76 protrudes leftward from the plate portion 74.

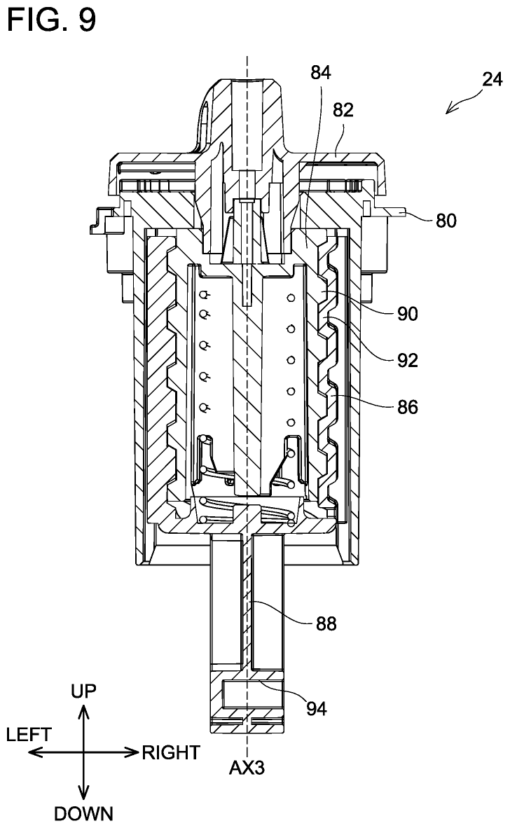

The height adjustment unit 24 is arranged to the left of the plate portion 74. As illustrated in FIG. 9, the height adjustment unit 24 comprises a fixed cylindrical portion 80, an adjustment dial portion 82, a first cylindrical portion 84, a second cylindrical portion 86, and a pin operation portion 88. The fixed cylindrical portion 80 is fixed to the upper housing 26 (see FIG. 1). The adjustment dial portion 82 is exposed to the outside of the upper housing 26 and is operated by the user. The adjustment dial portion 82 is supported by the fixed cylindrical portion 80 such that it is pivotable about a pivot axis AX3 extending in the up-down direction. The first and second cylindrical portions 84 and 86 are located inside the fixed cylindrical portion 80. The first cylindrical portion 84 has a substantially cylindrical shape whose bottom portion is at the upper end. The upper end of the first cylindrical portion 84 is connected to the adjustment dial portion 82. The first cylindrical portion 84 pivots about the pivot axis AX3 together with the adjustment dial portion 82. The first cylindrical portion 84 is not movable in the up-down direction. A spirally extending external thread portion 90 is defined on the outer surface of the first cylindrical portion 84. The second cylindrical portion 86 has a substantially cylindrical shape whose bottom portion is at the lower end. The second cylindrical portion 86 surrounds the outer surface of the first cylindrical portion 84. The second cylindrical portion 86 is supported by the fixed cylindrical portion 80 such that is not pivotable about the pivot axis AX3. A spirally extending internal thread portion 92 is defined on the inner surface of the second cylindrical portion 86. The internal thread portion 92 mates with the external thread portion 90. When the first cylindrical portion 84 pivots about the pivot axis AX3, the second cylindrical portion 86 moves relative to the first cylindrical portion 84 in the up-down direction. A pin operation portion 88 extends downward from the lower end of the second cylindrical portion 86. The pin operation portion 88 includes a pin receiving groove 94 that is recessed leftward from the right surface. As illustrated in FIG. 8, the pin receiving groove 94 has a substantially rectangular shape elongated in the front-rear direction. The pin portion 76 is received in the pin receiving groove 94 such that the pin portion 76 is rotatable and movable in the front-rear direction.

When the adjustment dial portion 82 pivots about the pivot axis AX3, the second cylindrical portion 86 moves in the up-down direction relative to the first cylindrical portion 84 due to the mating structure between the external thread portion 90 and the internal thread portion 92. This causes the pin operation portion 88 to move in the up-down direction. As illustrated in FIG. 8, when the pin operation portion 88 moves in the up-down direction, the pin portion 76 moves in the front-rear direction in the pin receiving groove 94. For example, when the pin operation portion 88 moves downward, the pin portion 76 moves rearward in the pin receiving groove 94. As a result, the plate portion 74 pivots such that the connection position between the plate portion 74 and the pin portion 76 is pushed downward. As a result, the central shaft portion 64 pivots in the pivot direction D1 about the pivot axis AX1, and the right shaft portion 68 supporting the right front wheel 60 and the left shaft portion 72 supporting the left front wheel 62 move such that they are pushed downward with respect to the central shaft portion 64. This pushes the housing 12 (see FIG. 6) upward to be away from the ground G (see FIG. 6). On the other hand, when the pin operation portion 88 moves upward, the pin portion 76 moves forward in the pin receiving groove 94. As a result, the plate portion 74 pivots such that the connection position between the plate portion 74 and the pin portion 76 is pushed upward. As a result, the central shaft portion 64 pivots about the pivot axis AX1 in the pivot direction D2 opposite to the pivot direction D1, and the right shaft portion 68 supporting the right front wheel 60 and the left shaft portion 72 supporting the left front wheel 62 move such that they are pushed upward with respect to the central shaft portion 64. This pushes the housing 12 downward to be closer to the ground G.

As illustrated in FIG. 1, the handle unit 8 comprises a lower frame 98, an upper frame 100, a right box 102, a left box 104, a main power switch 106, and an operation lever 108. The lower frame 98 has a substantially U-shape. The lower frame 98 extends from the housing 12 rearward and upward. The body unit 4 comprises a right handle bracket 110 and a left handle bracket 112 having a plate shape. The right front end of the lower frame 98 is attached to the right surface of the housing 12 via the right handle bracket 110. The left front end of the lower frame 98 is attached to the left surface of the housing 12 via the left handle bracket 112. The right handle bracket 110 and the left handle bracket 112 connect the lower frame 98 to the housing 12.

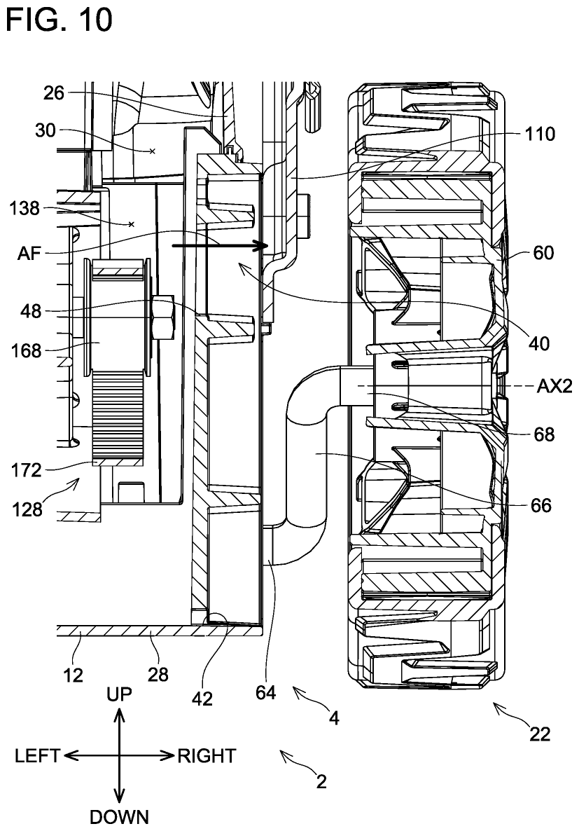

As illustrated in FIG. 3, the right handle bracket 110 is fixed to the upper housing 26 and lower housing 28. In the left-right direction, the right handle bracket 110 is arranged to face the first connection port 40. The right handle bracket 110 at least partially overlaps the first connection port 40 when the lawn maintenance machine 2 is viewed from the right toward the left. The right handle bracket 110 covers the first connection port 40 from the right. As illustrated in FIG. 10, in the left-right direction, the right handle bracket 110 is positioned between the right front wheel 60 and the first connection port 40. In the up-down direction, the lower end of the right handle bracket 110 is positioned downward the lower end of the first connection port 40, and the upper end of the right handle bracket 110 is positioned upward of the upper end of the first connection port 40. Thus, for example, when the right front wheel 60 is washed with liquid, the liquid hits the right handle bracket 110, and the right handle bracket 110 suppresses the liquid from entering the interior space 30 of the housing 12 through the first connection port 40. Since the first drain openings 42 are positioned downward of the first connection port 40, even when the liquid enters the interior space 30, the liquid is drained from the interior space 30 through the first drain openings 42. Further, since the first drain openings 42 are positioned to face the right front wheel 60 in the left-right direction, when for example the right front wheel 60 is washed with liquid, the liquid is suppressed from entering the interior space 30 of the housing 12 through the first drain openings 42.

As illustrated in FIG. 1, the upper frame 100 has a substantially U-shape. The right front end and the left front end of the upper frame 100 are fixed to the rear upper portion of the lower frame 98 to hold the lower frame 98 therebetween in the left-right direction. The upper frame 100 comprises a grip portion 114 extending in the left-right direction. The grip portion 114 is gripped by the user.

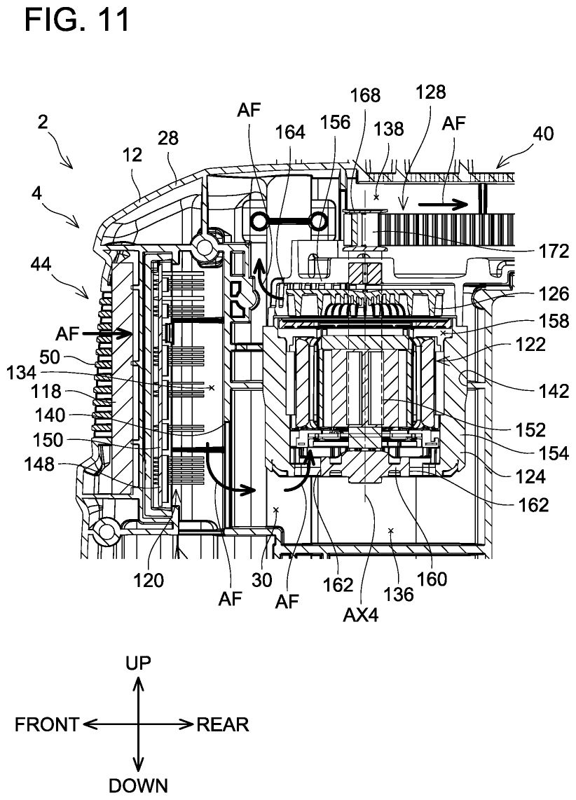

The right box 102 is fixed to the upper frame 100 at a position downward and rightward of the grip portion 114. The left box 104 is fixed to the upper frame 100 at a position downward and leftward of the grip portion 114. The main power switch 106 is arranged on the right box 102. The main power switch 106 switches on and off states of the lawn maintenance machine 2 when pressed by the user. The operation lever 108 is supported by the right box 102 and the left box 104 such that it can pivot about a pivot axis extending in the left-right direction. When the operation lever 108 is pulled in the direction approaching the grip portion 114 while the lawn maintenance machine 2 is in the on state, an electric motor 122 (see FIG. 11) to be described later is operated.

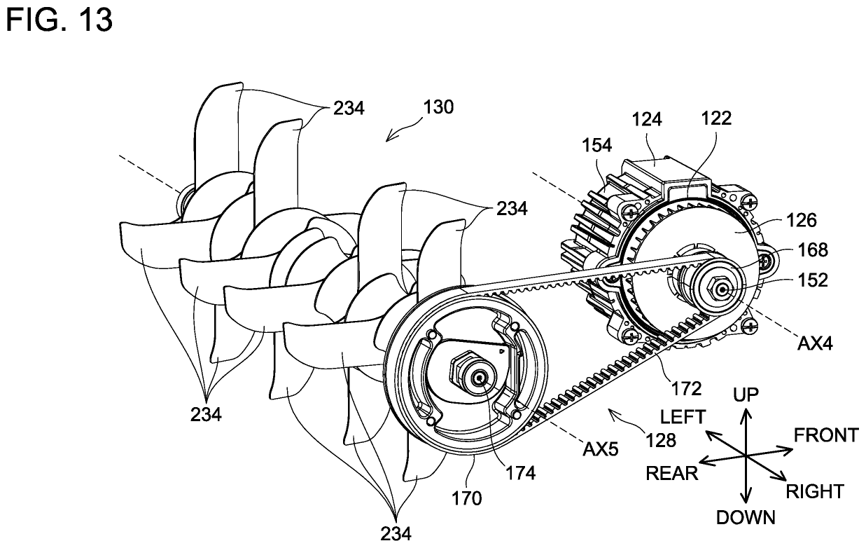

As illustrated in FIG. 11, the body unit 4 further comprises a sponge member 118, a control unit 120, the electric motor 122, a motor housing 124, a fan 126, a transmitting unit 128 (see FIG. 13), and a cutter unit 130 (see FIG. 13). The sponge member 118, the control unit 120, the electric motor 122, the motor housing 124, the fan 126, and the transmitting unit 128 are housed in the interior space 30 of the housing 12.

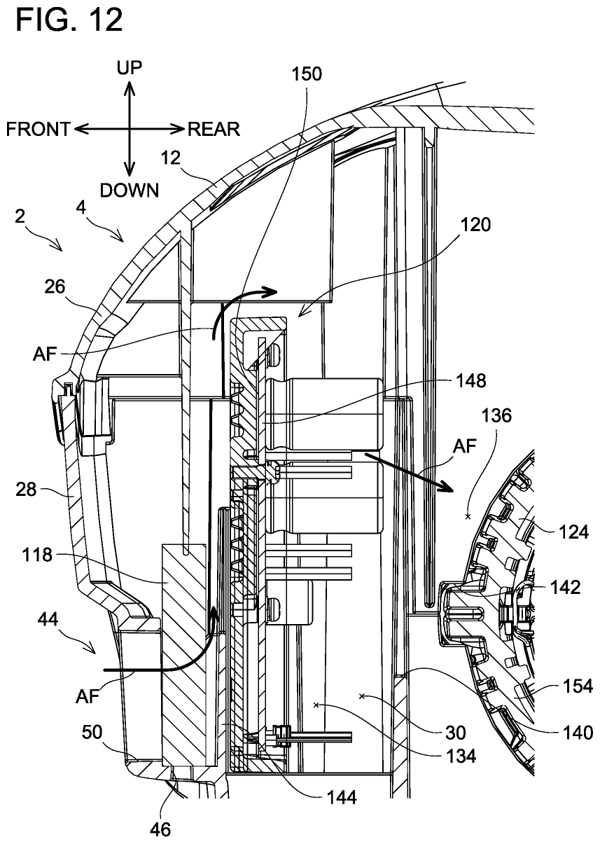

The interior space 30 comprises a first interior space 134, a second interior space 136, and a third interior space 138. The first interior space 134 is positioned forward of the first connection port 40 (see FIG. 10). As illustrated in FIG. 12, the first interior space 134 is connected to the outside of the lawn maintenance machine 2 via each of the second connection port 44 and the second drain openings 46. As illustrated in FIG. 11, the second interior space 136 is positioned rearward of the first interior space 134. The second interior space 136 is connected to the first interior space 134 via the first connection opening 140. The third interior space 138 is positioned to the right of the second interior space 136. The third interior space 138 is connected to the second interior space 136 via a second connection opening 142. As illustrated in FIG. 10, the third interior space 138 is also connected to the outside of the lawn maintenance machine 2 via each of the first connection port 40 and the first drain openings 42. The third interior space 138 is positioned to the left of the first connection port 40 and the first drain openings 42.

As illustrated in FIG. 12, the sponge member 118 is disposed in the first interior space 134. The sponge member 118 is made of a porous material. Air can flow through the interior of the sponge member 118. On the other hand, other foreign matter such as dust cannot pass through the sponge member 118. The sponge member 118 is positioned downward of (i.e., on the ground G side of) the connection point between the upper housing 26 and the lower housing 28. The lower housing 28 comprises a water-prevention wall 144 protruding upward at a position rearward of the second drain openings 46, and the sponge member 118 is positioned forward of the water-prevention wall 144. The sponge member 118 is disposed adjacent to the rear portion of the second connection port 44. In the front-rear direction, the sponge member 118 is disposed between the second connection port 44 and the water-prevention wall 144. The sponge member 118 is disposed adjacent to the upper side of the second drain openings 46. The sponge member 118 guides liquid (e.g., liquid that has entered from the second connection port 44) into the second drain openings 46. This allows the liquid to drain out of the lawn maintenance machine 2 through the second drain openings 46.

The control unit 120 is located in the first interior space 134. The control unit 120 controls the electric motor 122 in response to the operation of the operation lever 108 (see FIG. 1). The control unit 120 is located to the rear of the sponge member 118 and the water-prevention wall 144. The control unit 120 comprises a substrate 148 having a microcontroller and a plurality of switching elements (not illustrated). The substrate 148 has a plate shape. The substrate 148 is arranged such that its bottom surface 150 is orthogonal to the front-rear direction. The bottom surface 150 is along the up-down direction and the left-right direction.

As illustrated in FIG. 11, the electric motor 122 and motor housing 124 are inserted into the second connection opening 142. The electric motor 122 and motor housing 124 are located to the rear of the control unit 120. The electric motor 122 is, for example, a DC brushless motor. In a variant, the electric motor 122 may be an AC motor or a brush motor. The electric motor 122 comprises a motor shaft 152. In the front-rear direction, a position of the motor shaft 152 is substantially the same as a position of the front end of the first connection port 40. In FIG. 11, the first connection port 40 is illustrated by a dashed line. When power from the battery packs BP (see FIG. 5) is supplied to the electric motor 122, the motor shaft 152 rotates about a rotation axis AX4 extending in the left-right direction.

The motor housing 124 comprises a motor support portion 154 and a cover portion 156. The motor support portion 154 and the cover portion 156 define a housing space 158 that houses the electric motor 122 and the fan 126. The motor support portion 154 is fixed to the housing 12. The motor support portion 154 is inserted into the second connection opening 142. The motor support portion 154 supports the electric motor 122. The motor support portion 154 has a substantially cylindrical shape having a bottom 160. The motor support portion 154 has an intake opening 162 which penetrates through the bottom 160. The intake opening 162 connects the second interior space 136 and the housing space 158. The cover portion 156 is positioned to the right of the motor support portion 154. The cover portion 156 is fixed to the motor support portion 154 and also to the housing 12. The motor shaft 152 is inserted into the cover portion 156, and the cover portion 156 rotatably supports the motor shaft 152. In FIG. 11, the motor shaft 152 is illustrated by a dashed line. The cover portion 156 covers the right end opening of the motor support portion 154. The cover portion 156 includes an exhaust opening 164 that penetrates through the cover portion 156. The exhaust opening 164 connects the housing space 158 and the third interior space 138.

The fan 126 is arranged to the right of the electric motor 122. The fan 126 is fixed to the motor shaft 152. The fan 126 is, for example, a centrifugal fan. The fan 126 rotates with the motor shaft 152. This generates an air flow AF in the interior space 30. Specifically, as illustrated in FIG. 12, air flows into the first interior space 134 from outside the lawn maintenance machine 2 through the second connection port 44. The air that has flowed in flows through the sponge member 118. As a result, foreign matter that flowed into the first interior space 134 along with the air is trapped by the sponge member 118. The air then flows upward along the control unit 120, then bends and flows toward the first connection opening 140. This cools the control unit 120. The air then flows from the first interior space 134 into the second interior space 136 through the first connection opening 140. As illustrated in FIG. 11, the air that has flowed in flows from the second interior space 136 into the housing space 158 through the intake opening 162. The air then flows through the inside and outside of the electric motor 122. This cools the electric motor 122. The air is then delivered to the fan 126 and flows from the housing space 158 into the third interior space 138 through the exhaust opening 164. The air that has flowed in flows toward the right and then bends and flows rearward. As illustrated in FIG. 10, the air flows out of the lawn maintenance machine 2 by flowing through the first connection port 40 and then between the lower housing 28 and the right handle bracket 110.

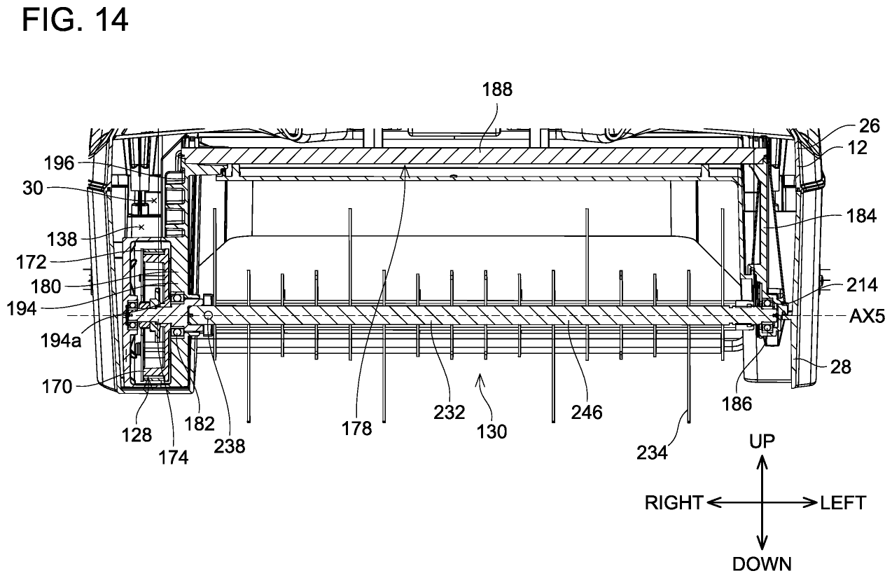

The transmitting unit 128 is arranged in the third interior space 138. The transmitting unit 128 is arranged to the left of the first connection port 40. The transmitting unit 128 is arranged at a position opposite the first connection port 40 in the left-right direction. As illustrated in FIG. 13, the transmitting unit 128 comprises a first pulley 168, a second pulley 170, a belt 172, and an output shaft 174. The first pulley 168 is fixed to the motor shaft 152. The second pulley 170 is positioned rearward of the first pulley 168. A diameter of the outer surface of the second pulley 170 is larger than a diameter of the outer surface of the first pulley 168. The belt 172 is wrapped over the first pulley 168 and the second pulley 170. When the first pulley 168 rotates, the belt 172 rotates about the first pulley 168 and the second pulley 170, by which the second pulley 170 rotates. The rotation speed of the second pulley 170 is lower than the rotation speed of the first pulley 168. The first pulley 168, the second pulley 170, and the belt 172 serve as a reduction gear. The output shaft 174 is fixed to the second pulley 170. The output shaft 174 rotates with the second pulley 170. As illustrated in FIG. 14, the output shaft 174 is inserted into the attaching unit 178 to be described later. The output shaft 174 is engaged with the cutter unit 130.

The body unit 4 comprises an attaching unit 178, and the cutter unit 130 is attached to the attaching unit 178. The attaching unit 178 is fixed to the lower housing 28 inside the lower housing 28. The attaching unit 178 is located at a rear lower portion of the lower housing 28.

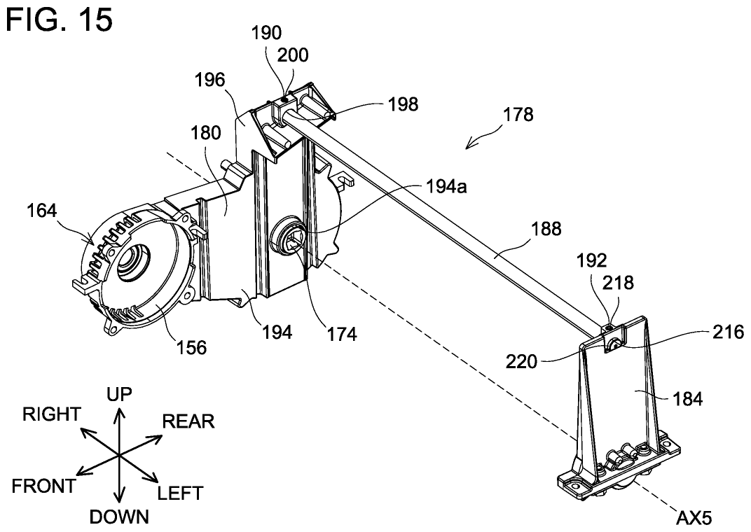

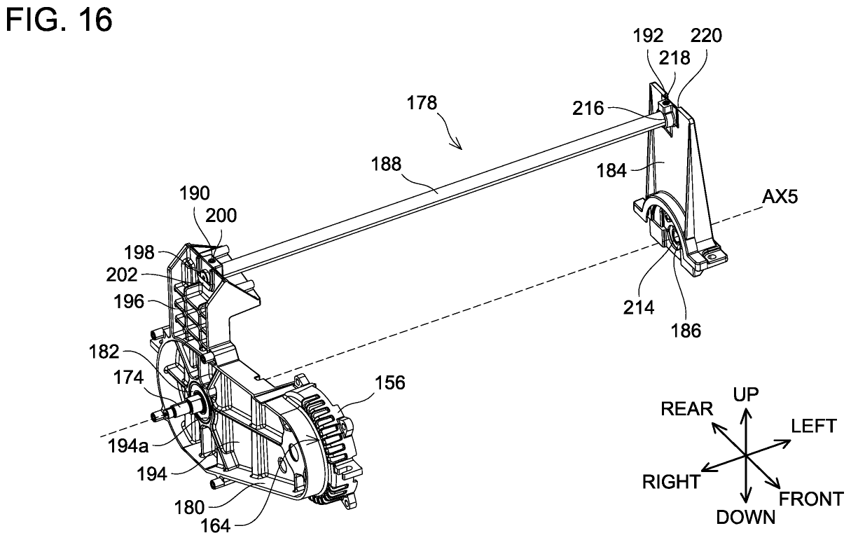

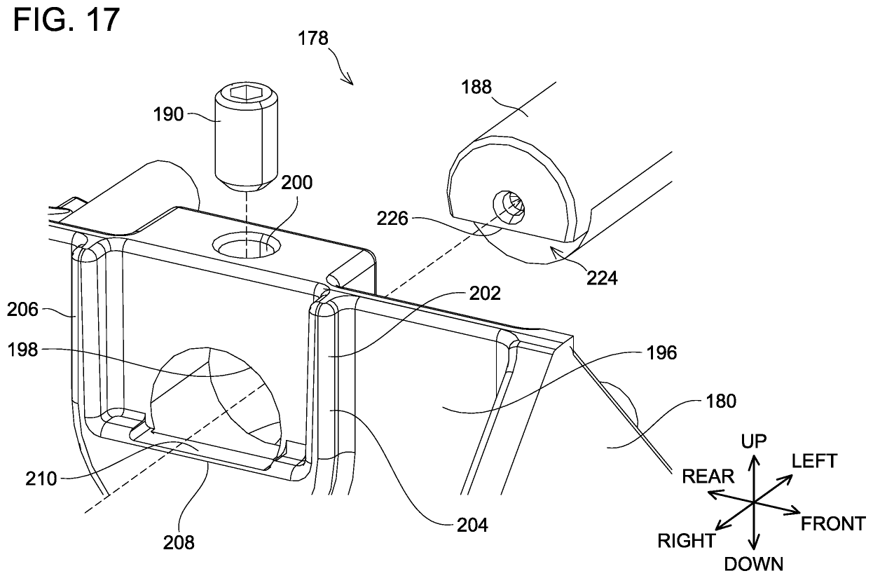

As illustrated in FIG. 15, the attaching unit 178 comprises a right support member 180, a right bearing 182 (see FIG. 16), a left support member 184, a left bearing 186 (see FIG. 16), a connection shaft 188, a right fixing screw 190 and a left fixing screw 192. The right support member 180 comprises a transmitting unit facing portion 194 and an upper protruding wall portion 196. As illustrated in FIG. 14, the transmitting unit facing portion 194 faces the transmitting unit 128 in the left-right direction. As illustrated in FIG. 16, the transmitting unit facing portion 194 has its longitudinal direction in the front-rear direction. A left front portion of the transmitting unit facing portion 194 is constituted of a cover portion 156. The transmitting unit facing portion 194 includes a through hole 194a that penetrates through the transmitting unit facing portion 194 in the left-right direction. The through hole 194a is positioned at a rear lower portion of the transmitting unit facing portion 194. The transmitting unit facing portion 194 supports the right bearing 182 within the through hole 194a. The output shaft 174 is inserted in the through hole 194a, and the right bearing 182 rotatably supports the output shaft 174. The upper protruding wall portion 196 protrudes upward from a rear upper portion of the transmitting unit facing portion 194. The upper protruding wall portion 196 is positioned upward of the through hole 194a. The upper protruding wall portion 196 includes a right shaft insertion opening 198 and a right screw insertion opening 200. The right shaft insertion opening 198 penetrates through the upper protruding wall portion 196 in the left-right direction. The right shaft insertion opening 198 is positioned upward of the upper protruding wall portion 196. The right screw insertion opening 200 is arranged upward of the right shaft insertion opening 198. The right screw insertion opening 200 extends in the up-down direction. The lower end of the right screw insertion opening 200 is connected to the right shaft insertion opening 198. The upper end of the right screw insertion opening 200 is open. As illustrated in FIG. 17, the cross-sectional shape of the right shaft insertion opening 198 has a substantially circular shape. The cross-sectional shape of the right screw insertion opening 200 has a substantially circular shape.

The right support member 180 further comprises a right rib portion 202 protruding rightward from the right surface of the upper protruding wall portion 196. The right rib portion 202 is arranged in the vicinity of the right shaft insertion opening 198. The right rib portion 202 comprises a front portion 204, a rear portion 206, and a lower portion 208. The front portion 204 extends in the up-down direction. The front portion 204 is positioned forward of the right shaft insertion opening 198. The rear portion 206 extends in the up-down direction. The rear portion 206 is arranged rearward of the front portion 204 and the right shaft insertion opening 198. The lower portion 208 extends in the front-rear direction. The lower portion 208 is connected to the lower end of the front portion 204 and the lower end of the rear portion 206. The lower portion 208 closes the vicinity of the lower end of the right shaft insertion opening 198 from the right. The lower portion 208 comprises a right contact surface 210 having a planar shape which is along the front-rear and left-right directions. The right contact surface 210 is positioned at the upper surface of the lower portion 208. The right contact surface 210 is adjacent to the right shaft insertion opening 198. In the up-down direction, the right contact surface 210 is positioned between the upper and lower ends of the right shaft insertion opening 198.

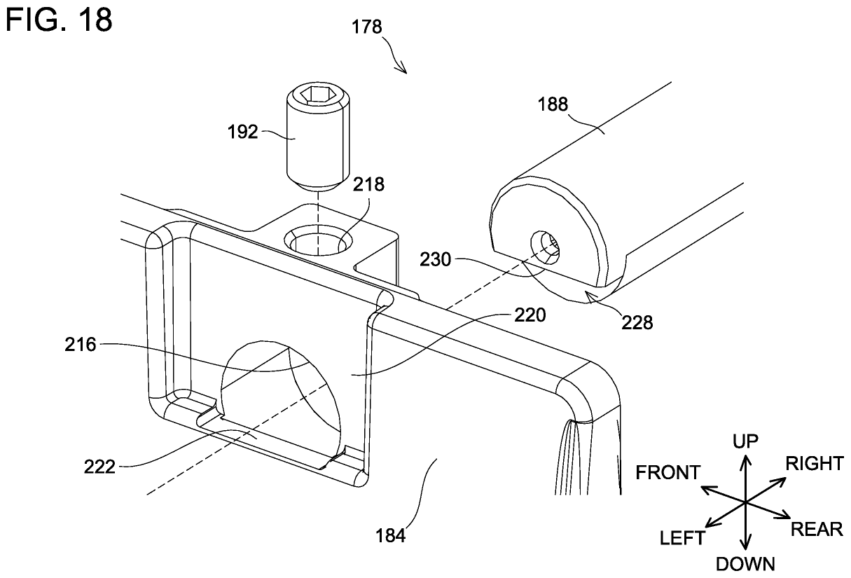

As illustrated in FIG. 16, the left support member 184 is arranged to the left of the right support member 180. The left support member 184 has its longitudinal direction in the up-down direction. The left support member 184 comprises a left bearing fixing portion 214 recessed from the right surface of the left support member 184. The left bearing fixing portion 214 is arranged at a position opposite the through hole 194a in the left-right direction. The left support member 184 supports the left bearing 186 within the left bearing fixing portion 214. The left bearing 186 rotatably supports the cutter unit 130 (see FIG. 14). The left support member 184 includes a left shaft insertion opening 216 and a left screw insertion opening 218. The left shaft insertion opening 216 extends leftward from the right surface of the left support member 184. The left shaft insertion opening 216 is positioned at an upper portion of the left support member 184. The left shaft insertion opening 216 is arranged at a position facing the right shaft insertion opening 198 in the left-right direction. The left screw insertion opening 218 is arranged upward of the left shaft insertion opening 216. The left screw insertion opening 218 extends in the up-down direction. The lower end of the left screw insertion opening 218 is connected to the left shaft insertion opening 216. The upper end of the left screw insertion opening 218 is open. As illustrated in FIG. 18, the cross-sectional shape of the left shaft insertion opening 216 has a substantially circular shape. The cross-sectional shape of the left screw insertion opening 218 has a substantially circular shape.

The left support member 184 includes a recess 220 recessed from the left surface of the left support member 184. The recess 220 is positioned at the upper end of the left support member 184. The recess 220 is connected to the upper surface of the left support member 184. The recess 220 is connected to the left end of the left shaft insertion opening 216. The recess 220 comprises a left contact surface 222 having a planar shape along the front-rear and left-right directions. The left contact surface 222 is positioned at the bottom of the recess 220. The left contact surface 222 is adjacent to the left shaft insertion opening 216. In the up-down direction, the left contact surface 222 is positioned between the upper and lower ends of the left shaft insertion opening 216.

As illustrated in FIG. 15, a connection shaft 188 connects the right support member 180 and the left support member 184. The connection shaft 188 extends in the left-right direction. The connection shaft 188 has an elongated, cylindrical shape. As illustrated in FIG. 17, the connection shaft 188 comprises a right notch 224 positioned at the right end of the connection shaft 188. The right notch 224 is recessed leftward from the right end surface of the connection shaft 188 and is recessed upward from the lower end of the outer surface of the connection shaft 188. The right notch 224 comprises a right alignment surface 226 extending in the left-right direction. The right alignment surface 226 has a planar shape along the left-right and front-rear directions. As illustrated in FIG. 18, the connection shaft 188 comprises a left notch 228 positioned at the left end of the connection shaft 188. The left notch 228 is recessed rightward from the left end surface of the connection shaft 188 and is recessed upward from the lower end of the outer surface of the connection shaft 188. The left notch 228 comprises a left alignment surface 230 extending in the left-right direction. The left alignment surface 230 has a planar shape along the left-right and front-rear directions.

Next, a method of fixing the connection shaft 188 to the right support member 180 and the left support member 184 will be described. First, the left end of the connection shaft 188 is inserted into the left shaft insertion opening 216 of the left support member 184 with the left alignment surface 230 of the connection shaft 188 facing down. Due to this, the left alignment surface 230 is brought into contact with the left contact surface 222 of the left support member 184. Next, as illustrated in FIG. 17, the right end of the connection shaft 188 is inserted into the right shaft insertion opening 198 of the right support member 180 with the right alignment surface 226 of the connection shaft 188 facing down. As a result, the right alignment surface 226 is brought into contact with the right contact surface 210 of the right support member 180. Next, with the connection shaft 188 pressed downward (i.e., with the right alignment surface 226 pressed against the right contact surface 210), a right fixing screw 190 is inserted into the right screw insertion opening 200 from above, and the right end of the connection shaft 188 is fixed to the right support member 180 by the right fixing screw 190. Finally, as illustrated in FIG. 18, with the connection shaft 188 pressed downward (i.e., with the left alignment surface 230 pressed against the left contact surface 222), the left fixing screw 192 is inserted into the left screw insertion opening 218 from above and the left end of the connection shaft 188 is fixed to the left support member 184 by the left fixing screw 192. Consequently, as illustrated in FIG. 16, the center axis of the right bearing 182 and the center axis of the left bearing 186 become colinear. As a result, vibrations caused by rotation of the cutter unit 130 can be suppressed as compared to a configuration in which the center axis of the right bearing 182 and the center axis of the left bearing 186 are not colinear.

As illustrated in FIG. 14, the right end of the cutter unit 130 is attached to the right support member 180 via the output shaft 174. The left end of the cutter unit 130 is attached to the left support member 184 via the left bearing 186. The cutter unit 130 is attached to the housing 12 via the attaching unit 178. The cutter unit 130 rotates about a rotation axis AX5 extending in the left-right direction when the output shaft 174 rotates. Consequently, thatch-removal, aeration, and cutting are performed. The rotational speed of the cutter unit 130 is, for example, 3200 rpm or more, preferably 2100 rpm or more and 3800 rpm or less.

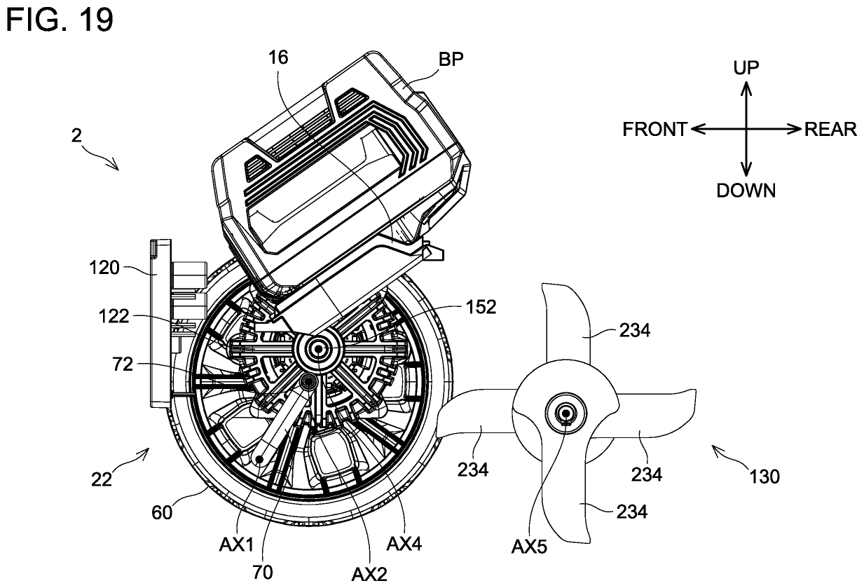

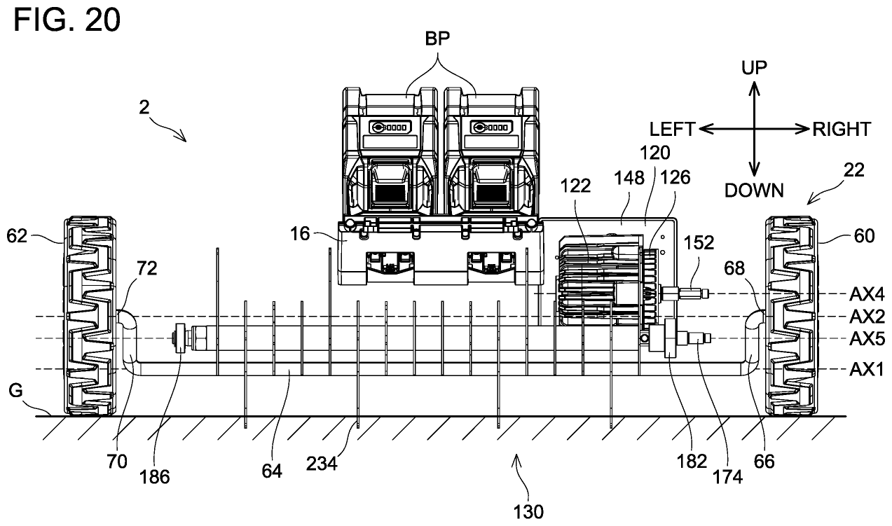

As illustrated in FIG. 19, when the lawn maintenance machine 2 is viewed from the left side along the rotation axis AX2 of the right front wheel 60 and the left front wheel 62 (see FIG. 20), the right front wheel 60 and the left front wheel 62 at least partially overlap the battery attaching unit 16, the battery packs BP, the control unit 120, the electric motor 122, and the fan 126 (see FIG. 20) in the left-right direction. When the lawn maintenance machine 2 is viewed from the left along the rotation axis AX2, the battery attaching unit 16 and the battery packs BP at least partially overlap the electric motor 122 and the fan 126 in the left-right direction. The battery attaching unit 16 and battery packs BP are positioned upward of the motor shaft 152 of the electric motor 122. The rotation axis AX4 of the motor shaft 152 is arranged upward of the rotation axis AX2 of the right front wheel 60 and left front wheel 62 (see FIG. 20) and the rotation axis AX5 of the cutter unit 130. The control unit 120 is arranged forward of the pivot axis AX1 and the rotation axis AX2. The control unit 120 is arranged forward of the battery attaching unit 16, the battery packs BP, the electric motor 122, the fan 126 (see FIG. 20), and the cutter unit 130. The rotation axis AX5 of the cutter unit 130 is arranged rearward of the battery attaching unit 16, the battery packs BP, the right front wheel 60, the left front wheel 62, the electric motor 122, and the fan 126 (see FIG. 20).

As illustrated in FIG. 20, the battery attaching unit 16 and the battery packs BP are arranged leftward of the electric motor 122. When the lawn maintenance machine 2 is viewed from the rear side along the front-rear direction orthogonal to the rotation axis AX2, the control unit 120 overlaps the entire electric motor 122 and the entire fan 126 in the front-rear direction and at least partially overlaps the right end of the cutter unit 130 and its vicinity in the front-rear direction. When the lawn maintenance machine 2 is viewed from the rear side along the front-rear direction, the electric motor 122 at least partially overlaps the right end of the cutter unit 130 and its vicinity in the front-rear direction.

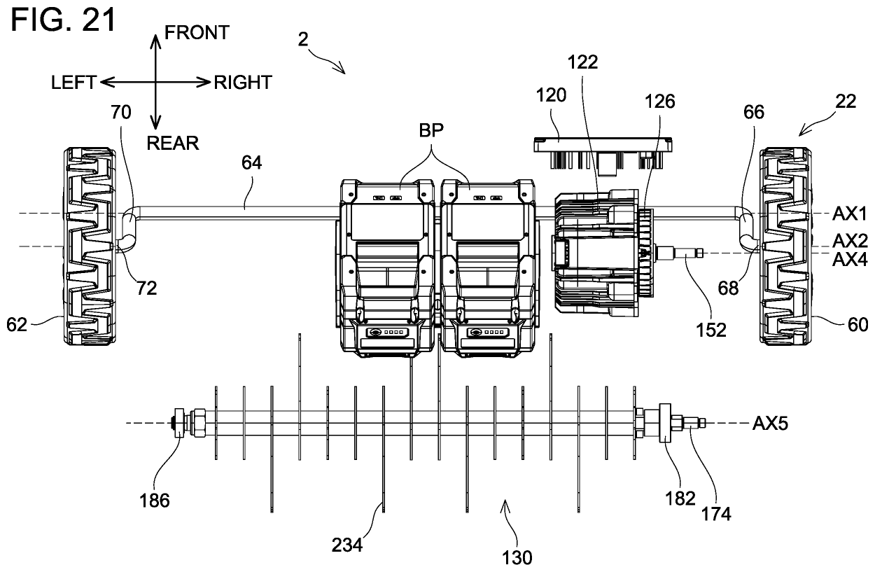

As illustrated in FIG. 21, when the lawn maintenance machine 2 is viewed from above along the up-down direction orthogonal to the rotation axis AX2, the central shaft portion 64 of the front wheel unit 22 at least partially overlaps the battery packs BP, the electric motor 122, and the fan 126 in the up-down direction. The control unit 120 is arranged forward of the central shaft portion 64.

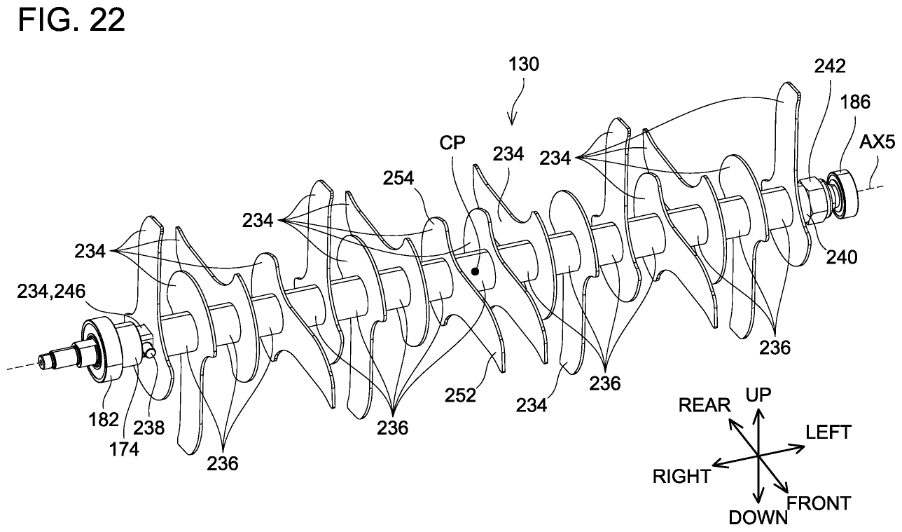

As illustrated in FIG. 22, the cutter unit 130 comprises a shaft 232, a plurality (sixteen in this embodiment) of cutter blades 234, a plurality (fifteen in this embodiment) of long spacers 236, a fixing pin 238, a short spacer 240, and a fixing nut 242.

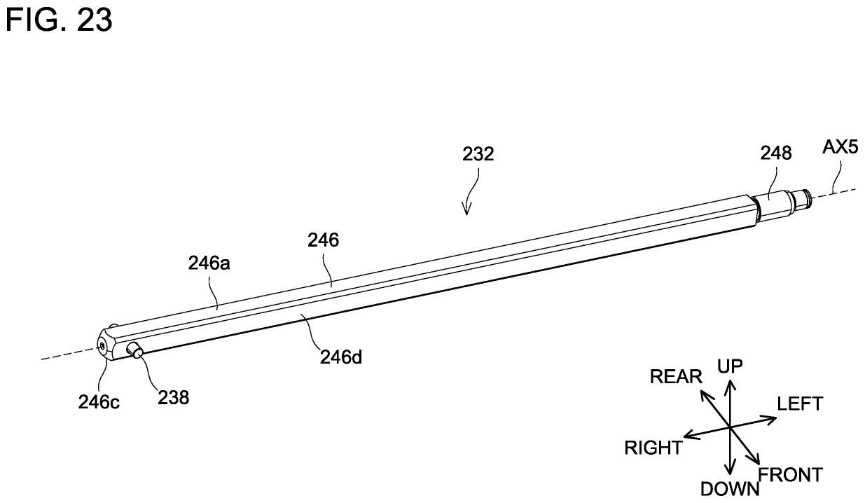

As illustrated in FIG. 23, the shaft 232 comprises a first portion 246 and a second portion 248. The first portion 246 extends in the left-right direction. The outer surface of the first portion 246 has a polygonal cross-sectional shape, and in the present embodiment, a substantially square cross-sectional shape. As illustrated in FIG. 14, the right end of the first portion 246 is engaged with the output shaft 174. As illustrated in FIG. 23, the second portion 248 is arranged leftward of the first portion 246. The outer surface of the second portion 248 has a substantially circular cross-sectional shape. As illustrated in FIG. 14, the left end of the second portion 248 is attached to the left support member 184 via the left bearing 186.

As illustrated in FIG. 22, a plurality of cutter blades 234 is arranged on the first portion 246. The plurality of cutter blades 234 is aligned in the left-right direction. The number of plurality of cutter blades 234 is an even number. The cutter blades 234 are, for example, made of a metallic material. In a variant, the cutter blades 234 may be made of a resin material. The cutter blades 234 have a flat plate shape. In a variant, the cutter blades 234 may have a curved plate shape. A weight of the cutter blades 234 is, for example, 2000 g or less, and preferably 1000 g or more and 3000 g or less.

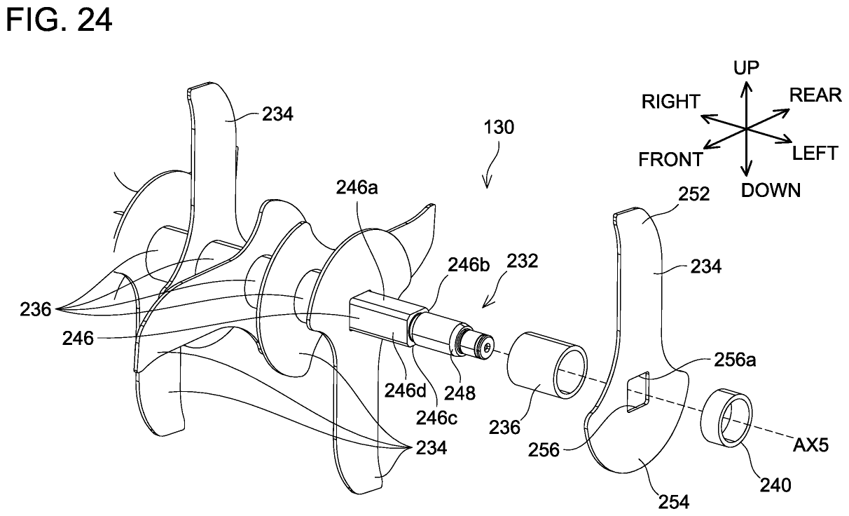

As illustrated in FIG. 24, each of the cutter blades 234 comprises a cutter part 252 and an attaching part 254. The cutter part 252 extends in a direction separating away from the shaft 232. The cutter part 252 extends substantially linearly. The cutter part 252 performs aeration, cutting and thatch-removal. The attaching part 254 is connected to the cutter part 252. The attaching part 254 has an attaching opening 256 that penetrates through the attaching part 254 in the thickness direction (in the left-right direction). The attaching opening 256 has a polygonal cross-sectional shape, and in this embodiment, a substantially square cross-sectional shape. The cross-sectional shape of the attaching opening 256 is identical to the cross-sectional shape of the outer surface of the first portion 246. The first portion 246 is inserted into each of the attaching openings 256. When the first portion 246 is inserted into the attaching openings 256, four surfaces that constitute the outer surface of the first portion 246 respectively face four surfaces of the attaching openings 256. This suppresses the cutter blades 234 from rotating about the first portion 246. In each of the cutter blades 234 of the present embodiment, the attaching part 254 is designed to be relatively large. This can reduce the difference between a weight of a part of each cutter blade 234 on the cutter part 252 side relative to the attaching opening 256 and a weight of a part of the cutter blade 234 opposite the cutter part 252 relative to the attaching opening 256. Therefore, the balance of each of the cutter blades 234 itself can be suppressed from deteriorating.

A posture of each of the cutter blades 234 with respect to the first portion 246 is changed by changing the relationships in positions at which the four surfaces of the outer surface of the first portion 246 face the four surfaces of the attaching opening 256. Each of the attaching opening 256 comprises a surface 256a that is closest to the cutter part 252 among the surfaces of the attaching opening 256. When the surface 256a of the attaching opening 256 faces the upper surface 246a of the outer surface of the first portion 246, the cutter blade 234 has a first posture in which the cutter part 252 extends upward from the first portion 246. When the surface 256a of the attaching opening 256 faces the rear surface 246b of the outer surface of the first portion 246, the cutter blade 234 has a second posture in which the cutter part 252 extends rearward from the first portion 246. Further, when the surface 256a of the attaching opening 256 faces the lower surface 246c of the outer surface of the first portion 246, the cutter blade 234 has a third posture in which the cutter part 252 extends downward from the first portion 246. When the surface 256a of the attaching opening 256 faces the front surface 246d of the outer surface of the first portion 246, the cutter blade 234 has a fourth posture in which the cutter part 252 extends forward from the first portion 246. In the circumferential direction of the rotation axis AX5, when the position of the cutter part 252 in the first posture is defined as 0 degrees, the cutter part 252 in the second posture is at a position of 90 degrees, the cutter part 252 in the third posture is at a position of 180 degrees, the cutter part 252 in the fourth posture is at a position of 270 degrees. The cutter parts 252 in the respective postures are equally spaced in the circumferential direction of the rotation axis AX5. An interval between the cutter parts 252 in the respective postures in the circumferential direction (90 degrees in this embodiment) is substantially the same as the value obtained by dividing 360 degrees by the number of surfaces on the outer surface of the first portion 246 (four in this embodiment).

As illustrated in FIG. 22, the plurality of long spacers 236 is inserted into the first portion 246. The long spacers 236 have a substantially cylindrical shape. The long spacers 236 are held between the cutter blades 234 adjacent in the left-right direction. As a result, the plurality of cutter blades 234 are equally spaced in the left-right direction.

The fixing pin 238 is arranged in the vicinity of the right end of the first portion 246. The fixing pin 238 is inserted into the first portion 246 such that it is orthogonal to the rotation axis AX5. The fixing pin 238 contacts the cutter blade 234 at the rightmost position from the right side. The fixing pin 238 suppresses the cutter blades 234 from moving rightward beyond the fixing pin 238. The fixing pin 238 contacts the output shaft 174 from the left side. The fixing pin 238 suppresses the cutter blade 234 at the rightmost position from contacting the output shaft 174.

The short spacer 240 is arranged in the vicinity of the left end of the first portion 246. The shaft 232 is inserted into the short spacer 240. The short spacer 240 has a substantially cylindrical shape. The short spacer 240 is in contact with the cutter blade 234 at the leftmost position from the left side.

The fixing nut 242 is fixed to the second portion 248. The fixing nut 242 contacts the short spacer 240 from the left side. In the left-right direction, the plurality of cutter blades 234, the plurality of long spacers 236, and the short spacer 240 are held by the fixing pin 238 and the fixing nut 242. Consequently, the positions of the plurality of cutter blades 234, the plurality of long spacers 236, and the short spacer 240 with respect to the shaft 232 in the left-right direction are fixed.

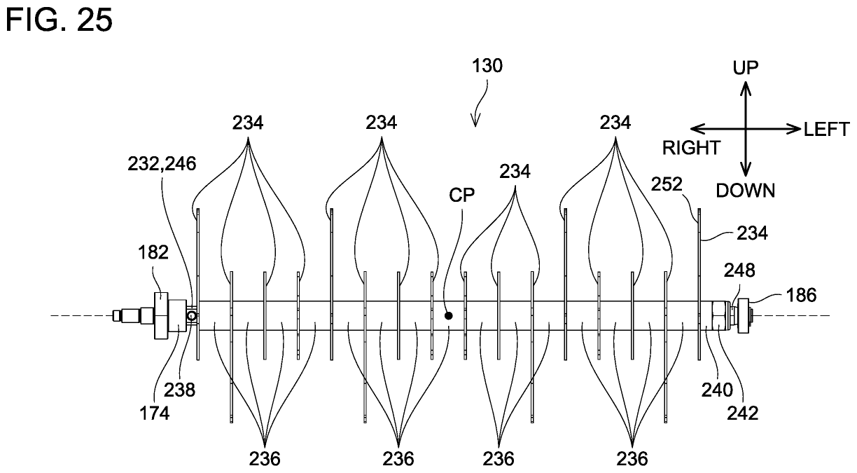

The positions and postures of the plurality of cutter blades 234 in the left-right direction are described. In the following, explanations are made by defining the center in the left-right direction between the cutter blade 234 at the rightmost position and the cutter blade 234 at the leftmost position as the center position CP. As illustrated in FIG. 25, the center position CP is at the center in the left-right direction between the eighth cutter blade 234 from the right and the ninth cutter blade 234 from the right. The cutter blade 234 is not disposed at the center position CP. The number of cutter blades 234 disposed to the right of the center position CP (eight in this embodiment) is the same as the number of cutter blades 234 disposed to the left of the center position CP (eight in this embodiment).

The positions at which the cutter blades 234 disposed to the right of the center position CP are attached on the shaft 232 are substantially the same as the positions at which the cutter blades 234 disposed to the left of the center position CP are attached on the shaft 232. The disposition of the eight cutter blades 234 in the left-right direction as viewed from the center position CP toward the right is substantially the same as the disposition of the eight cutter blades 234 in the left-right direction when viewed from the center position CP toward the left. That is, the distance between the center position CP and the Nth cutter blade 234 to the right from the center position CP is identical to the distance between the center position CP and the Nth cutter blade 234 to the left from the center position CP.

As illustrated in FIG. 22, the postures of the plurality of cutter blades 234 change in turn according to the cycle of the fourth posture, the second posture, the third posture, and the first posture from the center position CP to the right. The postures of the plurality of cutter blades 234 changes in turn according to the cycle of the fourth posture, the second posture, the third posture, and the first posture from the center position CP to the left. The posture of the Nth cutter blade 234 to the right of the center position CP is the same as the posture of the Nth cutter blade 234 to the left of the center position CP. That is, the postures of the two cutter blades 234 at the same distance from the center position CP in the left-right directions are the same.

### Effects

The lawn maintenance machine 2 of the present embodiment is configured to maintain a lawn on the ground G as the lawn maintenance machine 2 moves forward on the ground G. The lawn maintenance machine 2 comprises: the right front wheel 60 and the left front wheel 62 (examples of a pair of wheels) configured to rotate on the ground G; the handle unit 8 configured to be gripped by the user while the lawn maintenance machine 2 is moving; the cutter unit 130 (an example of a working unit) configured to work on the ground G; the electric motor 122 configured to drive the cutter unit 130; the fan 126 configured to rotate by operation of the electric motor 122; the housing 12 configured to support the cutter unit 130 and housing the electric motor 122 and the fan 126; and the right handle bracket 110 (an example of a wall) disposed outside the housing 12 and attached to the housing 12. The housing 12 has the first connection opening 48 (an example of a connection opening) which connects the inside and the outside of the housing 12 and through which air flows by a rotation of the fan 126. The right handle bracket 110 is disposed to face the first connection opening 48.

According to the above configuration, when the lawn maintenance machine 2 is being washed with liquid, the liquid hits the right handle bracket 110, by which the liquid can be suppressed from reaching the first connection opening 48. This can suppress the liquid from flowing into the housing 12 through the first connection opening 48.

The right handle bracket 110 is disposed between the first connection opening 48 and the right front wheel 60.

As the lawn maintenance machine 2 moves on the ground G, soil and lawn may adhere to the right front wheel 60. According to the above configuration, even when the right front wheel 60 is washed with liquid, the liquid hits the right handle bracket 110, by which the liquid can be suppressed from reaching the first connection opening 48. This can suppress the liquid from flowing into the housing 12 through the first connection opening 48.

The right handle bracket 110 (an example of a handle bracket) connects the handle unit 8 and the housing 12.

According to the above configuration, the handle unit 8 and the housing 12 can be connected using one component, and liquid can be suppressed from flowing into the housing 12 through the first connection opening 48 when the lawn maintenance machine 2 is washed with liquid.

The electric motor 122 at least partially overlaps the right front wheel 60 when the lawn maintenance machine 2 is viewed along the rotation axis AX2 of the right front wheel 60 and the left front wheel 62.

According to the above configuration, the electric motor 122, which is a heavy object, is arranged in the vicinity of the ground G. This can suppress the housing 12 from tilting with respect to the ground G when an external force acts on the housing 12, as compared to a configuration in which the electric motor 122 is not arranged in the vicinity of the ground G.

The lawn maintenance machine 2 further comprises the control unit 120 housed in the housing 12 and configured to control the electric motor 122. The control unit 120 at least partially overlaps the electric motor 122 when the lawn maintenance machine 2 is viewed from the rear side.

When the fan 126 rotates, air flows through the electric motor 122. According to the above configuration, the distance between the electric motor 122 and the control unit 120 can be shortened. This allows the control unit 120 to be cooled more efficiently by the air flowing through the electric motor 122.

The control unit 120 is disposed forward of the electric motor 122.

According to the above configuration, the space rearward of the electric motor 122 can be made more compact than in a configuration in which the control unit 120 is arranged rearward of the electric motor 122. Thus, for example, when the cutter unit 130 is arranged rearward of the electric motor 122, the distance between the electric motor 122 and the cutter unit 130 can be shortened.

The lawn maintenance machine 2 further comprises the battery packs BP (examples of a battery) configured to supply electric power to the electric motor 122. The battery packs BP at least partially overlap the electric motor 122 when the lawn maintenance machine 2 is viewed along the rotation axis AX2 of the right front wheel 60 and the left front wheel 62.

According to the above configuration, the battery packs BP, which are heavy objects, are arranged in the vicinity of the ground G. This can suppress the housing 12 from tilting with respect to the ground G when an external force acts on the housing 12, as compared to a configuration in which the battery packs BP are not arranged in the vicinity of the ground G.

The housing 12 has the first drain opening 42 (an example of a drain opening) disposed closer to the ground G than the first connection opening 48 and connecting the inside and the outside of the housing 12. The first drain opening 42 is disposed at a position facing the right front wheel 60.

According to the above configuration, even when liquid flows into the housing 12 through the first connection opening 48, the liquid can be drained out of the housing 12 through the first drain opening 42. In addition, when the lawn maintenance machine 2 is being washed with liquid, the liquid hits the right front wheel 60, by which the liquid can be suppressed from reaching the first drain opening 42. This can suppress the liquid from flowing into the housing 12 through the first drain opening 42.

### Variant

The lawn maintenance machine 2 of one embodiment may be a working machine comprising a non-removable built-in battery. In this case, the built-in battery is charged by connecting a power cable to an external power source.

The lawn maintenance machine 2 of one embodiment may comprise a power cable that can be connected to an external power source. In this case, the lawn maintenance machine 2 may be configured to operate by electric power supplied from the external power source via the power cable.

In the lawn maintenance machine 2 of one embodiment, the first connection port 40 may face a member different from the right handle bracket 110.

In the lawn maintenance machine 2 of one embodiment, when the fan 126 rotates, air may flow into the interior of the housing 12 from the first connection port 40, then flow in the order of the third interior space 138, the housing space 158, the second interior space 136, the first interior space 134, and then be exhausted out of the housing 12 from the second connection port 44.

In the cutter unit 130 of one embodiment, the structure for attaching the cutter blades 234 to the shaft 232 is not limited to the structure described in the embodiment. For example, the shaft 232 may comprise attaching parts disposed on the upper surface 246a, the rear surface 246b, the lower surface 246c, and the front surface 246d. The cutter blades 234 may be configured to be attached to the attaching parts disposed on the upper surface 246a, the rear surface 246b, the lower surface 246c, and the front surface 246d.

In the cutter unit 130 of one embodiment, the postures of the cutter blades 234 with respect to the shaft 232 are not limited to four types, and for example, the postures may be three types, or five or more types. For example, the outer surface of the first portion 246 of the shaft 232 may have a triangular, pentagonal, hexagonal, or octagonal shape, and the cross-sectional shape of the attaching opening 256 of each of the cutter blades 234 may have a triangular, pentagonal, hexagonal, or octagonal shape. The outer surface of the first portion 246 may have a shape other than a polygonal shape, and the cross-sectional shapes of the attaching openings 256 may have a shape other than a polygonal shape.

In the cutter unit 130 of one embodiment, the plurality of cutter blades 234 disposed to the right of the center position CP may not be equally spaced in the left-right direction. In this case, the plurality of cutter blades 234 disposed to the left of the center position CP are not equally spaced in the left-right direction.

What is claimed is:

1. A lawn maintenance machine configured to maintain lawn on a ground as the lawn maintenance machine moves on the ground forward, the lawn maintenance machine comprising:
a pair of wheels configured to rotate on the ground;
a handle unit configured to be gripped by a user while the lawn maintenance machine is moving;
a working unit configured to work on the ground;
an electric motor configured to drive the working unit;
a fan configured to rotate by operation of the electric motor;
a housing configured to support the working unit and housing the electric motor and the fan; and
a wall disposed outside the housing and attached to the housing,
wherein
the housing has a connection opening which connects an inside and an outside of the housing and through which air flows by rotation of the fan, and
the wall is disposed to face the connection opening.

2. The lawn maintenance machine according to claim 1, wherein the wall is disposed between the connection opening and one of the pair of wheels.

3. The lawn maintenance machine according to claim 1, wherein the wall is a handle bracket connecting the handle unit and the housing.

4. The lawn maintenance machine according to claim 1, wherein the electric motor at least partially overlaps at least one of the pair of wheels when the lawn maintenance machine is viewed along a rotation axis of the pair of wheels.

5. The lawn maintenance machine according to claim 4, further comprising a control unit housed in the housing and configured to control the electric motor,
wherein
the control unit at least partially overlaps the electric motor when the lawn maintenance machine is viewed from a rear side.

6. The lawn maintenance machine according to claim 5, wherein the control unit is disposed forward of the electric motor.

7. The lawn maintenance machine according to claim 4, further comprising a battery configured to supply electric power to the electric motor,
wherein
the battery at least partially overlaps the electric motor when the lawn maintenance machine is viewed along the rotation axis of the pair of wheels.

8. The lawn maintenance machine according to claim 1, wherein
the housing has a drain opening disposed closer to the ground than the connection opening and connecting the inside and the outside of the housing, and
the drain opening is disposed at a position facing one of the pair of wheels.

9. The lawn maintenance machine according to claim 2, wherein
the wall is a handle bracket connecting the handle unit and the housing,
the electric motor at least partially overlaps at least one of the pair of wheels when the lawn maintenance machine is viewed along a rotation axis of the pair of wheels,
the lawn maintenance machine further comprises a control unit housed in the housing and configured to control the electric motor,
the control unit at least partially overlaps the electric motor when the lawn maintenance machine is viewed from a rear side,
the control unit is disposed forward of the electric motor,
the lawn maintenance machine further comprises a battery configured to supply electric power to the electric motor,
the battery at least partially overlaps the electric motor when the lawn maintenance machine is viewed along the rotation axis of the pair of wheels,
the housing has a drain opening disposed closer to the ground than the connection opening and connecting the inside and the outside of the housing, and
the drain opening is disposed at a position facing one of the pair of wheels.
